(19) United States
(12) Patent Application Publication
(10) Pub. No.: US 2025/0389202 A1
(43) Pub. Date: Dec. 25, 2025

(54) GAS TURBINE-DRIVEN SHARED-ROTOR ELECTRIC GENERATOR

(71) Applicant: The Board of Regents for the Oklahoma Agricultural and Mechanical Colleges, Stillwater, OK (US)

(72) Inventors: Joshua Johnsen, Tulsa, OK (US); Kurt P. Rouser, Stillwater, OK (US)

(21) Appl. No.: 18/639,545

(22) Filed: Apr. 18, 2024

Related U.S. Application Data
(60) Provisional application No. 63/496,791, filed on Apr. 18, 2023.

(51) Int. Cl. F01D 15/10; F01D 25/30; H02K 7/18

(52) U.S. Cl. CPC F01D 15/10; H02K 7/1823; F01D 25/30; F05D 2220/766

(57) ABSTRACT

An electrical turbine generator is herein disclosed. The electrical turbine generator comprises a movable shaft and a rotor assembly. The rotor assembly comprises a plurality of blades not configured to compress gas and a generator rotor, the plurality of blades coupled to the generator rotor, the rotor assembly being supported by the movable shaft; a stator assembly including a plurality of stator windings electro-magnetically coupled to the rotor assembly; a housing supporting the rotor assembly and the stator assembly, the housing having an exhaust inlet opening and exhaust outlet opening, the exhaust inlet opening and the exhaust outlet opening aligned with the blades of the rotor assembly; and a power converter in communication with the stator windings to convert electrical energy induced in the stator windings into an output current having at least one of a steady frequency and a steady voltage.

### REFERENCE TO RELATED APPLICATIONS

The present patent application claims priority to U.S. Ser. No. 63/496,791 filed on Apr. 18, 2023, the entire content of which is hereby incorporated herein by reference.

### BACKGROUND

Gas turbine engines are internal combustion engines that generate power or thrust through using various forms of the Brayton thermodynamic cycle. They can be viewed as machines whose power is derived directly from the change in kinetic energy of the working fluid.

A turboelectric system is a hybrid gas-electric power system in which a gas turbine engine is used to create shaft work to drive an electric generator. The power produced by this turbogenerator is often augmented with a battery to improve operability and increase takeoff power density. At an unmanned vehicle scale turbine engines generally have a lower pressure ratio than their piston engine counterparts at the same power level, which can lead to an overall lower thermal efficiency. However, turbine engines have unique enabling features such as higher maximum speeds, operability at high altitudes, running on heavy fuels, and a relatively high power to weight ratio. These features make turbine engines attractive for certain vehicle requirements and mobile generator applications. There are variety of different turbogenerator configurations with the generator located in front of the turbine engine, embedded inside the engine, and finally being driven in the rear of the gas turbine engine similar to a turboprop.

Other mechanical electric machines with an in-runner fan or turbine do exist and are niche technologies that will be noted for the sake of completeness. The idea of using a rotating machine as the inner portion of a motor/generator is not new, but rather there is a distinct lack of information on the topic related to gas turbines.

U.S. Pat. No. 6,729,140 describes a gas compressor and turbine blade tip mounted electric machine. The focus of U.S. Pat. No. 6,729,140 was building an embedded light weight starter for a commercial sized turbofan engine, with the potential to also generate a relatively small amount of electric power.

Turbines with radially mounted magnets are so called “rim-driven turbines” used in tidal flow energy generation and also marine rim-driven thrusters. There are also some wind turbines using low speed propellers. All of these machines are operating at relatively low rotational speeds with a focus on generating high torque at those low speeds. These systems are quite removed from the temperature, rotational speed, and power density requirements of axial gas turbines engines.

### SUMMARY OF THE INVENTION

Disclosed herein is a generator system comprising a gas turbine engine and an electrical turbine generator. In some embodiments, the generator system may be referred to as having a “shared rotor.” The term “shared rotor” refers to the gas turbine engine and the electrical turbine generator both include rotors, but the rotor for the gas turbine engine is not connected to the rotor of the electrical turbine engine with a connecting shaft. Rather, the gas turbine engine and the electrical turbine engine are mated together so that a housing connects the gas turbine engine to the electrical turbine generator. In particular, the housing fluidly connects an exhaust gas housing of the gas turbine engine to an exhaust inlet opening of the electrical turbine generator.

Because the gas turbine engine and the electrical turbine generator are connected by a housing, the generator system of the present disclosure has many advantages over the conventional turbo generators, including a potential reduction in the volume of the turbogenerator by combining the gas turbine engine and the electrical turbine generator, the ability to retrofit existing gas turbine engines, the removal of a secondary shaft, the removal of any gearbox, and the removal of additional exhaust ducting. A rotor, of the electrical turbine generator may also not be connected to the main engine drive shaft of the gas turbine engine, allowing the rotor of the electrical turbine generator to be driven at a much lower rate of rotation (the main drive shaft of a 100-N thrust engine can be over 150,000 RPM). The electrical turbine generator also does not obstruct the inlet flow and instead acts downstream of the inlet. Finally, the electrical turbine generator may not be embedded inside the gas turbine engine, which would require a complex cooling scheme for a stator of the electrical turbine generator and a total redesign of the overall gas turbine engine.

In one embodiment, an electrical turbine generator includes a movable shaft, a rotor assembly, a stator assembly, a housing, and a power converter. The rotor assembly includes a plurality of blades not configured to compress gas and a generator rotor. The plurality of blades are coupled to the generator rotor. The rotor assembly is supported by the movable shaft. The stator assembly includes a plurality of stator windings electro-magnetically coupled to the rotor assembly. The housing supports the rotor assembly and the stator assembly and has an exhaust inlet opening and exhaust outlet opening. The exhaust inlet opening and the exhaust outlet opening are aligned with the blades of the rotor assembly. The power converter is in communication with the stator windings to convert electrical energy induced in the stator windings into an output current having at least one of a steady frequency and a steady voltage.

In another embodiment, an apparatus comprises a gas turbine engine and an electrical turbine generator. The gas turbine engine includes a compressor section, a combustion section a turbine section, and an exhaust housing. The compressor section comprises a turbine shaft and compresses incoming air. The combustion section receives the compressed incoming air and ignites fuel thereby producing high-pressure and high-temperature gases. The turbine section includes turbine blades supported by the turbine shaft. The turbine blades receive the high-pressure and high-temperature gases so as to induce rotation to the turbine blades and the turbine shaft thereby extracting energy from the high-pressure and high-temperature gases and converting at least a portion of the high-pressure and high-temperature gases into rotational mechanical energy. The exhaust gas housing defines a turbine exhaust gas outlet downstream of the turbine section. The electrical turbine generator comprises a movable shaft, a rotor assembly, a stator assembly, a housing, and a power converter. The rotor assembly is supported by and surrounds the movable shaft and includes a plurality of blades coupled to a generator rotor. The stator assembly includes a plurality of stator windings electro-magnetically coupled to the rotor assembly. The housing supports the rotor assembly and the stator assembly and has an exhaust inlet opening and exhaust outlet opening. The exhaust inlet opening and the exhaust outlet opening are aligned with the blades of the rotor assembly. The housing fluidly connects the exhaust gas housing of the gas turbine engine to the exhaust inlet opening of the electrical turbine generator. The power converter is in communication with the stator windings to convert electrical energy induced in the stator windings into an output current having at least one of a steady frequency and a steady voltage.

In another embodiment, a method, comprises positioning a gas inlet of a rotor assembly of an electrical turbine generator to receive an exhaust gas stream from a gas turbine engine, the electrical turbine generator having an electrical rotor assembly coupled to the rotor assembly, and a stator assembly electro-magnetically coupled with the electrical rotor assembly.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1A is a block diagram of an exemplary embodiment of a generator system constructed in accordance with the present disclosure.

FIG. 1B is a cross-section of an exemplary embodiment of the gas turbine engine of FIG. 1A.

FIG. 1C is a perspective view of an exemplary embodiment of the turbine of FIG. 1B constructed in accordance with the present disclosure.

FIG. 2 is a cross-sectional diagram of an exemplary embodiment of a switch reluctance generator constructed in accordance with the present disclosure.

FIG. 3 is a perspective view of an exemplary embodiment of a solid rotor induction generator constructed in accordance with the present disclosure.

FIG. 4 is a perspective, partial view of a surface permanent magnet generator constructed in accordance with the present disclosure in which a housing surrounding the permanent magnets is not shown to permit viewing of the permanent magnets.

FIG. 5 is a partial, side elevation view of a portion of the surface permanent magnet generator depicted in FIG. 4.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description, and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

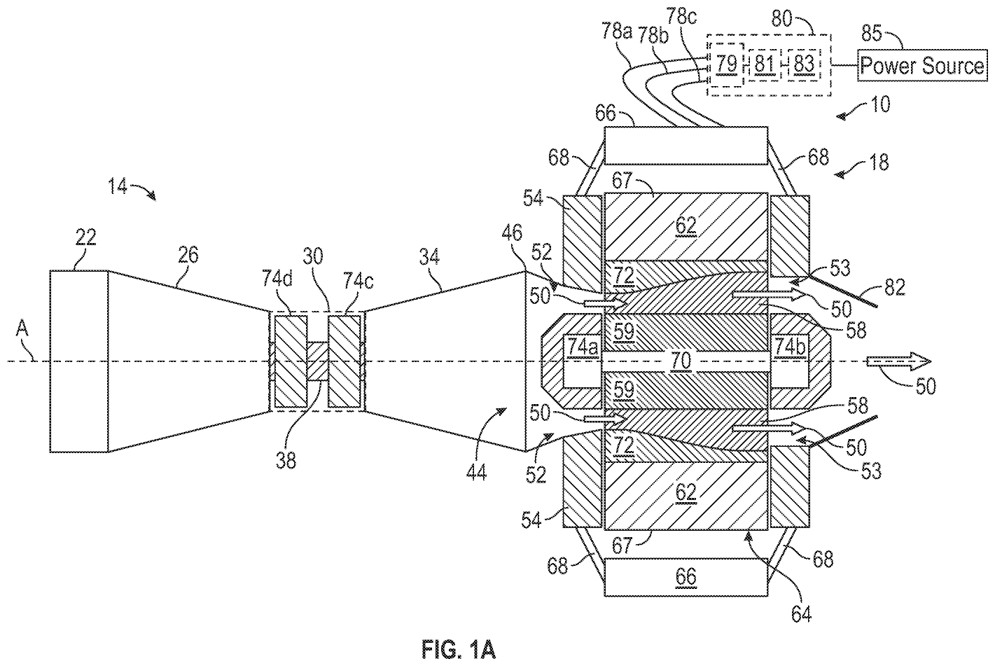

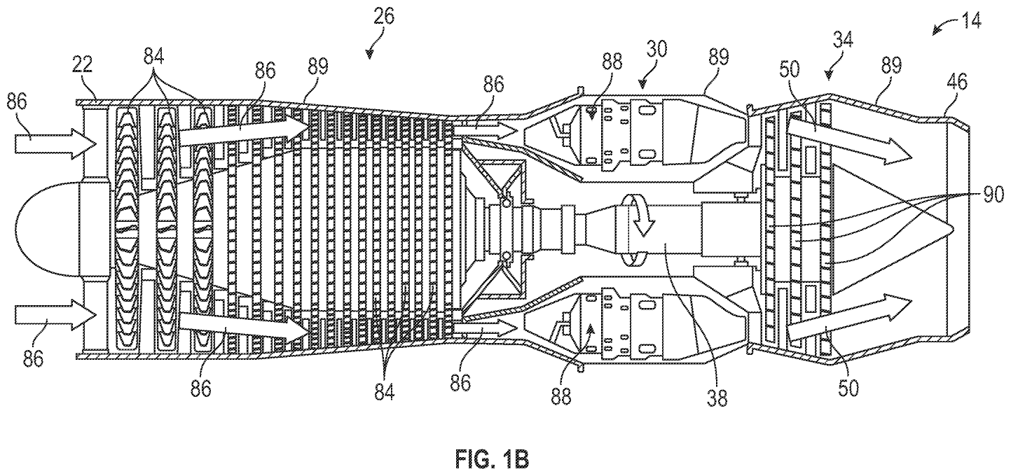

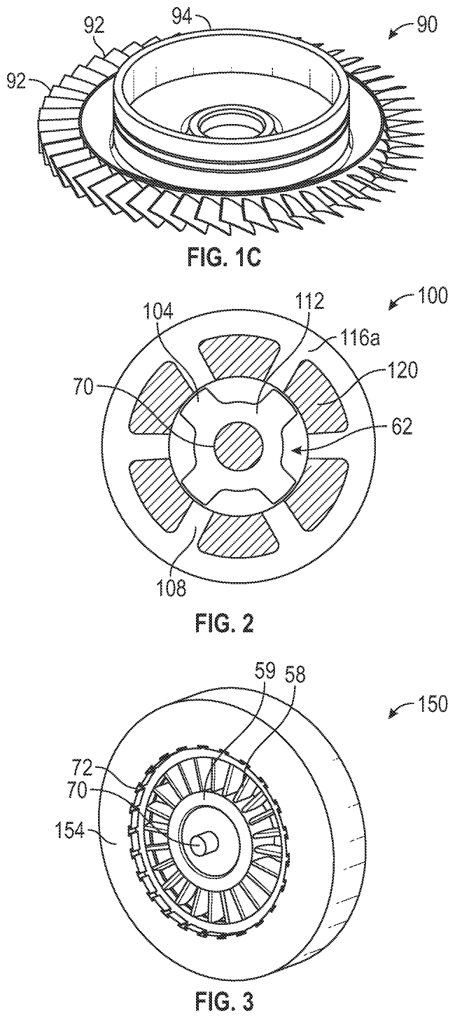

Referring now to the drawings, and in particular to FIG. 1A, shown therein is an apparatus, referred to hereinafter as a generator system 10, constructed in accordance with the present disclosure. Generally, the generator system 10 comprises a gas turbine engine 14 and an electrical turbine generator 18. In one embodiment, the gas turbine engine 14 is a gas turbine. In one embodiment, the gas turbine engine 14 comprises a multistage axial compressor and multistage axial turbine. In another embodiment, the gas turbine engine 14 comprises a single-stage centrifugal compressor and single-stage axial turbine. For example, the gas turbine engine 14 (e.g., engine) may be a JetCat P100 (Ingenieurb ÜRO CAT, M. Zipperer GmbH, Ballrechten-Dottingen, Germany).

In one embodiment, the gas turbine engine 14 comprises an inlet 22, a compressor 26, a combustor 30, and a turbine section 34 connected to the compressor 26 via a first shaft 38, e.g., turbine shaft. As combustion gases flow through the turbine section 34, the turbine section 34 rotates the first shaft 38 and the compressor 26.

In one embodiment, incoming air (e.g., atmospheric air) enters the gas turbine engine 14 via the inlet 22. The incoming air then passes through the compressor 26, e.g., compressor section, where a pressure of the incoming air is increased, thereby also increasing a temperature of the incoming air. The compressed incoming air is then mixed with fuel and ignited/combusted in the combustor 30, e.g., combustion section, at a constant pressure thereby producing high-pressure and high-temperature gases. A portion of energy in the combustion gases is extracted by the turbine section 34 to rotate the first shaft 38, thereby driving the compressor 26.

In one embodiment, the turbine section 34, e.g., turbine section, comprises a plurality of turbine blades supported by the first shaft 38. The plurality of turbine blades receive the high-pressure and high-temperature gases from the combustor 30 to induce rotation to the plurality of turbine blades and to the first shaft 38, thereby extracting a portion of energy and converting at least the portion of energy into rotational mechanical energy.

In one embodiment, the gas turbine engine 14 further comprises an exhaust gas housing 46 operable to couple the gas turbine engine 14 to the electrical turbine generator 18. The combustion gases thus flow through the turbine section 34, through a turbine exhaust gas outlet 44 of the exhaust gas housing 46, and into the electrical turbine generator 18 along exhaust gas stream 50 via a gas inlet 52. In one embodiment, the exhaust gas housing 46 anchors the gas turbine engine 14 to the electrical turbine generator 18 and directs combustion/exhaust gases into the gas inlet 52. In one embodiment, the exhaust gas housing 46 is bolted to the gas turbine engine 14 such that the turbine exhaust gas outlet 44 is in fluid communication with the exhaust gas housing 46 wherein the exhaust gas housing 46 transfers the exhaust gas stream 50 to the gas inlet 52.

In one embodiment, the electrical turbine generator 18 comprises the housing 54 supporting a plurality of turbine blades 58, a generator rotor 62 associated with and mechanically coupled to the plurality of turbine blades 58 via a mechanical interface 72, and a stator assembly 66 electro-magnetically coupled with the generator rotor 62. The electrical turbine generator 18 also includes a rotor assembly. The rotor assembly may include a blade root 59, a plurality of turbine blades 58, a mechanical interface 72 and a generator rotor 62. The mechanical interface 72 may mechanically couple the generator rotor 62 and the plurality of turbine blades 58.

Each of the plurality of turbine blades 58 is further mechanically coupled to the blade root 59. As shown in FIG. 1A, the exhaust gas stream 50 may pass through/around the plurality of turbine blades 58, however, in one embodiment, the exhaust gas stream 50 does not pass through the blade root 59. In one embodiment, the blade root 59 may be constructed of a solid material such that there is no fluid flow through the blade root 59.

As shown in FIG. 1A, the electrical turbine generator 18 further includes a movable shaft, i.e., a second shaft 70, that can be implemented as a rotatable shaft. The second shaft 70 is supported by the housing 54, such as by bearings 74, e.g., a first bearing 74a and a second bearing 74b. In the embodiment shown, the second shaft 70 supports the rotor assembly 64 such that the rotor assembly 64 rotates about the second shaft 70. In one embodiment, the plurality of turbine blades 58 are not configured to compress gas. In one embodiment, the second shaft 70, the blade root 59, the plurality of turbine blades 58, and at least a portion of the mechanical interface 72 may be constructed of a single, contiguous material. The single, contiguous material may be, for example, 3D printed or otherwise manufactured using an additive manufacturing process.

In one embodiment, the electrical turbine generator 18 comprises one or more turbine stator blade extending from a housing 54 and disposed within the gas inlet 52. The one or more turbine stator blade may be integrally formed with the housing 54 such that the one or more turbine stator blade does not rotate about the second shaft 70. In one embodiment, the one or more turbine stator blade is operable to accelerate the exhaust gas stream 50 as the exhaust gas stream 50 enters the electrical turbine generator 18.

Passage of the exhaust gas stream 50 past/across the plurality of turbine blades 58 places rotational force on the rotor assembly 64 thereby causing the rotor assembly 64 and the second shaft 70 to rotate. Due to the mechanical coupling of the mechanical interface 72 to the generator rotor 62 and to the plurality of turbine blades 58, rotation of the plurality of turbine blades 58 causes the rotor assembly 64 to rotate.

As the exhaust gas stream 50 causes the plurality of turbine blades 58, and thus the rotor assembly 64 to rotate about the second shaft 70, the housing 54 supporting the rotor assembly 64, e.g., via the first bearing 74a and the second bearing 74b, may not be rotating, e.g., the first bearing 74a and the second bearing 74b isolate rotation of the second shaft 70 from the housing 54. In other words, rotation of the rotor assembly 64 is isolated from the housing 54 by the one or more bearing 74, e.g., the first bearing 74a and the second bearing 74b, such that the rotor assembly 64 rotates independently of the housing 54. In some embodiments, the housing 54 is mechanically fixed to the gas turbine engine 14 via the exhaust gas housing 46 and thereby moves with the gas turbine engine 14.

In one embodiment, the housing 54 may be coated in a non-conductive coating and/or the housing 54 may be constructed of a non-conductive material, thereby reducing and/or eliminating creation of eddy currents in the housing 54. In one embodiment, the bearings 74 may be selected such that the bearings 74 are operable at high RPMs such as at RPMs between 10,000 RPM and 150,000 RPM, and may be selected based at least in part on a calculated max RPM of the gas turbine engine 14 in combination with the rotor assembly 64.

In one embodiment, one or more of the plurality of turbine blades 58 may be constructed of annealed cobalt-iron super alloy or another material having a high electromagnetic saturation (e.g., of 2.0 Tesla or greater) and low specific core loss.

In one embodiment, the first shaft 38 may be supported within the combustor 30 via one or more third bearing 74c and/or fourth bearing 74d. In these embodiments, the first shaft 38 and the second shaft 70 are separate and rotate independently, i.e., the first shaft 38 and the second shaft 70 are not mechanically linked or coupled. Thus, the first shaft 38 may be rotating at a first RPM and the second shaft 70 may be rotating at a second RPM different from the first RPM. The first shaft 38 and the second shaft 70 may be in a spaced apart, parallel relationship. In some embodiments, the first shaft 38 and the second shaft 70 are axially aligned along Axis A, as shown in FIG. 1A.

In one embodiment, a radius of the generator rotor 62 may be 48 mm and a radius of the plurality of turbine blades 58 is 31 mm. In other embodiments, the generator rotor 62 and the plurality of turbine blades 58 is sized such that the plurality of turbine blades 58 is operable to receive the exhaust gas stream 50, i.e., combustion gases from the gas turbine engine 14.

In one embodiment, the rotor assembly 64 comprises the plurality of turbine blades 58, shown in FIG. 3. The plurality of turbine blades 58 may have a particular shape, twist, and/or taper selected such that the plurality of turbine blades 58 are operable to be responsive to the exhaust gas stream 50 passing through the electrical turbine generator 18 and convert at least some energy of the exhaust gas stream 50 into rotational movement about the second shaft 70.

In one embodiment, the housing 54 may be designed such that ambient air may pass into and/or through the generator rotor 62 and/or the stator assembly 66 of the electrical turbine generator 18 to lower a temperature within the generator rotor 62 and/or the stator assembly 66 of the electrical turbine generator 18. For example, the stator assembly 66 may experience an increase in temperature from both the exhaust gas stream 50 passing nearby as well as from the induced current passing within the stator assembly 66. Increased temperature at the stator assembly 66 may result in lowered electrical efficiency of the stator assembly 66. Therefore, in some embodiments, it may be advantageous to pass ambient air, i.e., cooler air, across the stator assembly 66 to lower the temperature. In one embodiment, the stator assembly 66 may be mechanically coupled to the housing 54 by one or more support 68, such that the stator assembly 66 does not rotate about the shaft 70. The one or more support 68 may be non-moving, rigid supports. In one embodiment, the one or more support 68 is constructed of a metal and fastened to the housing 54 and to the stator assembly 66 in order to restrict movement of the housing 54 relative to the stator assembly 66. In one embodiment, the one or more support 68 suspends the stator assembly 66 a desired distance from the generator rotor 62 such that the stator assembly 66 (and, in some embodiments, the generator rotor 62) may be cooled by air passing over the one or more support 68 and between the stator assembly 66 and the generator rotor 62. In one embodiment, the desired distance is selected based on electrical generator characteristics as well as a flow rate of cooling air. In one embodiment, the housing 54 does not extend beyond an outer radius 67 of the generator rotor 62.

In one embodiment, the generator rotor 62 and the stator assembly 66 of the electrical turbine generator 18 may be one of a switch reluctance generator, induction generator (such as a solid rotor induction generator), and a permanent magnet generator (such as a surface mounted permanent magnet generator). In one embodiment, the electrical turbine generator 18 may only include a single rotor assembly 64 and in these embodiments, the electric turbine generator 18 may only be considered a single stage axial turbine. In some embodiments, the electrical turbine generator 18 may include multiple rotor assemblies 64 in a serial fashion such that the exhaust gas stream 50 passes sequentially through the multiple rotor assemblies 64. In other embodiments the plurality of turbine blades 58 may comprise multiple series of turbine blades 58 spaced longitudinally along the second shaft 70. Although the first shaft 38 and the second shaft 70 are not physically coupled, in one embodiment, the rotor assembly 64 of the electrical turbine generator 18 may be considered as shared-with the rotor 84 (FIG. 1B) of the gas turbine engine 14 due to the first shaft 38 and the second shaft 70 being coaxially aligned (e.g., aligned along Axis A as shown in FIG. 1A) and due to both the rotor assembly 64 and the rotor of the gas turbine engine 14 having an induced rotation due to the combustion gases resulting in the exhaust gas stream 50. In other words, the rotor assembly 64 and the rotor of the gas turbine engine 14 may be considered in a serial relationship.

In one embodiment, the combustion gases of the exhaust gas stream 50, flowing through the electrical turbine generator 18 pass along the turbine blades 58 of the rotor assembly 64 thereby inducing the rotor assembly 64, and the associated generator rotor 62, to rotate about the second shaft 70. The generator rotor 62, passing adjacent the stator assembly 66 as the generator rotor 62 rotates around the second shaft 70 induces a current supplied to conductive leads 78a-c due to reluctance.

In one embodiment, the rotor assembly 64 is one or more rotor assembly 64. In this embodiment, a first rotor assembly and a second rotor assembly may be axially aligned. In one embodiment, the first rotor assembly and the second rotor assembly are disposed along the second shaft 70. In another embodiment, the first rotor assembly and the second rotor assembly each have the second shaft 70. In this embodiment, the first rotor assembly and the second rotor assembly may be disposed in counter-rotating manner (e.g., with two rotor stages disposed axially one after the other on different second shafts 70 and spinning in opposing directions). In one embodiment, if the first rotor assembly and the second rotor assembly share the second shaft 70, a first turbine stage and a second turbine stage may be disposed on either side of a stator stage configured to redirect the flow, e.g., exhaust gasses.

In one embodiment, the generator rotor 62 may be constructed of a steel or an iron lamination material. In other embodiments, the generator rotor 62 is constructed of a material such that the generator rotor 62 propagates strong magnetic fields without saturating.

In one embodiment, the induced current is a three-phase alternating current. In another embodiment, the induced current is a two-phase alternating current or a single-phase alternating current. In one embodiment, the induced current is passed through a current regulator, e.g., power converter 80, to convert the induced current into an output current having a predetermined format, e.g., steady frequency and a steady voltage. The power converter 80 can be an inverter or an active rectifier.

In one embodiment, the power converter 80 may further include one or more controllers operable to receive an electrical signal, such as from a sensor 79 or from the one or more conductive leads 78, to determine a rotor position of the generator rotor 62. The sensor 79 may be one or more of a hall-effect sensor, optical encoder, or magnetic encoder.

In one embodiment, the power converter 80 may comprise an Asymmetric H-Bridge for a 6/4 switch reluctance generator (as described below).

In some embodiments, the power converter 80 may be electrically connected to a power source 85, such as a battery or a supercapacitor, and used to cool the stator assembly 66 and the rotor assembly 64. Specifically, when the hot combustion gasses from the gas turbine engine 14 are no longer being supplied to the rotor assembly 64 (e.g., when the gas turbine engine 14 is turned off), the power converter 80 may draw power from the power source 85 and supply power to the stator assembly 66 for causing the rotor assembly 64 to rotate thereby cooling the rotor assembly 64 and the stator assembly 66. The power converter 80 may supply power to the stator assembly 66 for a period of time until the rotor assembly 64 is below a predetermined temperature.

In one embodiment, the power converter 80 may further include one or more processor 81, or microprocessor, and one or more memory 83, e.g., a non-transitory processor-readable medium storing processor-executable instructions that when executed by the processor causes the processor 81 to perform one or more action, such as receive the electrical signal, determine the rotor position, and/or transmit one or more control signal.

In one embodiment, the electrical turbine generator 18 further comprises a nozzle 82 in line with the exhaust gas stream 50 such that, as the exhaust gas stream 50 passes through a gas outlet 53 in the housing 54, the exhaust gas stream 50 is directed into the nozzle 82. The nozzle 82 may be shaped and used to act on the combustion gases (e.g., exhaust gas stream 50) to accelerate the exhaust gas stream 50 and generate thrust as the exhaust gas stream 50 exits the nozzle 82 or to otherwise redirect the combustion gases.

In one embodiment, the electrical turbine generator 18 further comprises one or more exit guide vane extending from the housing 54 and disposed within the gas outlet 53. The one or more exit guide vane may be integrally formed with the housing 54 such that the one or more exit guide vane does not rotate about the second shaft 70. In one embodiment, the one or more exit guide vane is operable to straighten out and/or remove vortices induced in the exhaust gas stream 50 as the exhaust gas stream 50 enters the nozzle 82. In one embodiment, the one or more exit guide vane is operable to induce a flow axially aligned along (or substantially parallel with) Axis A in the exhaust gas stream 50, which may result in an increase to thrust generation.

Referring now to FIG. 1B, shown therein is a cross-section of an exemplary embodiment of the gas turbine engine 14 of FIG. 1A utilizing rotors 84 to induce airflow through the gas turbine engine 14 as illustrated by arrows 86. Rotors 84 suck air into the inlet 22 of the gas turbine engine 14 and compress the incoming air into combustion chambers 88 within the combustor 30. In one embodiment, the gas turbine engine 14 further includes a housing 89 surrounding and/or supporting the compressor 26, the combustor 30, and the turbine section 34. In one embodiment, the housing 89 does not surround the electrical turbine generator 18. In other words, the electrical turbine generator 18 is outside of the housing 89.

The compressed incoming air is then mixed with fuel and ignited/combusted in the combustor 30, e.g., combustion section, at a constant pressure thereby producing high-pressure and high-temperature gases which are expelled out the exhaust gas housing 46 as the exhaust gas stream 50.

The high-pressure and high-temperature gases (e.g., the exhaust gas stream 50) spin one or more turbine 90 that connects through the first shaft 38 to turn rotors 84. A portion of energy in the exhaust gas stream 50 is extracted by the turbine section 34 via the one or more turbine 90 as the exhaust gas stream 50 passes over one or more blade 92 to rotate the first shaft 38, thereby driving the compressor 26.

The combination of the rotors 84, turbines 90 and first shaft 38 may turn at thousands of revolutions per minute. Therefore, the rotors 84 are precisely balanced and of high mechanical integrity, because an unbalanced or broken rotor can fly apart, destroying the gas turbine engine 14 and possibly generating high speed shrapnel that can damage adjacent objects, such as wings or fuselage of an aircraft.

Referring now to FIG. 1C, shown therein is a perspective view of an exemplary embodiment of the turbine 90 constructed in accordance with the present disclosure. In one embodiment, each turbine 90 may include one or more blade 92 mounted discretely on a common structure 94. The blades 92 and common structure 94 must be precisely formed and attached so that the turbine 90 is balanced. Such structures, for example, are compatible with repair of individual nicked or broken blades 92 (e.g., due to an engine aspirating foreign matter, such as a bird). In such cases, the blade 92 that needs to be repaired can be removed and a new blade 92 attached in the same manner as for the initial manufacture of the turbine 90. In another embodiment, each turbine 90 may include one or more blade 92 integrally formed into the common structure 94.

Referring now to FIG. 2, shown therein is a cross-sectional diagram of an exemplary embodiment of a switch reluctance generator 100 constructed in accordance with the present disclosure. Generally, the switch reluctance generator 100 has a high efficiency, no permanent magnet, and a relatively high power density. In one embodiment, the switch reluctance generator 100 is a brush-less generator with a predetermined number of phases, and may have three phases as described above. In one embodiment, the generator rotor 62 and the stator assembly 66 of the electrical turbine generator 18, may be the switch reluctance generator 100.

In one embodiment, the switch reluctance generator 100 is “double salient”, e.g., poles, or teeth 104, 108, protrude from both a rotor 112 of the generator rotor 62 and a first stator assembly 116a constructed in accordance with the stator assembly 66 described above. As used herein, poles extending from the rotor 112 may be referred to as rotor teeth 104 while poles extending from the first stator assembly 116a may be referred to as stator teeth 108.

In one embodiment, the switch reluctance generator 100 does not include permanent magnets. In this embodiment, magnetic excitation is caused by coils, or windings 120, e.g., stator windings, in the first stator assembly 116a as the rotor 112 rotates about the second shaft 70. The switch reluctance generator 100, as shown in FIG. 2, comprises six stator teeth 108 and four rotor teeth 104. For this reason, the switch reluctance generator 100 may be referred to as a 6/4 switch reluctance generator.

In one embodiment, the switch reluctance generator 100 comprises more than one first stator assembly 116a. For example, the switch reluctance generator 100 may comprise two or more first stator assemblies 116a aligned along axis A (FIG. 1A) such that as the generator rotor 62 rotates around the second shaft 70, the generator rotor 62 induces an electrical charge and/or power in each of the two or more first stator assemblies 116a.

Referring now to FIG. 3, shown therein is a perspective view of an exemplary embodiment of a rotor assembly 150 of a solid rotor induction generator constructed in accordance with the present disclosure. The rotor assembly 150 may comprise a solid rotor 154 coupled to the mechanical interface 72, which is in turn mechanically coupled to the plurality of turbine blades 58. The plurality of turbine blades 58 are mechanically coupled to the blade root 59 and, thus, to the second shaft 70.

In one embodiment, an advantage of the solid rotor induction generator over the switch reluctance generator 100 is a simpler rotor design as the solid rotor 154 does not include rotor teeth 104 as described above, thereby allowing the solid rotor induction generator to operate at a much higher RPM than the switch reluctance generator 100.

Gas turbine engines, such as the gas turbine engine 14, produce a high gas operating temperature (the gas temperature may be around 700° C.). The electrical turbine generator 18 acts as a secondary turbine thus the temperature is lower than the gas operating temperature of the gas turbine engine 14. The heat transfer from the gas turbine engine 14 to the electrical turbine generator 18 causes the electrical turbine generator 18 to have an elevated operating temperature from more than just electrical losses. The electrical turbine generator 18 being outside of the gas turbine engine 14, however, which significantly reduces cooling requirements.

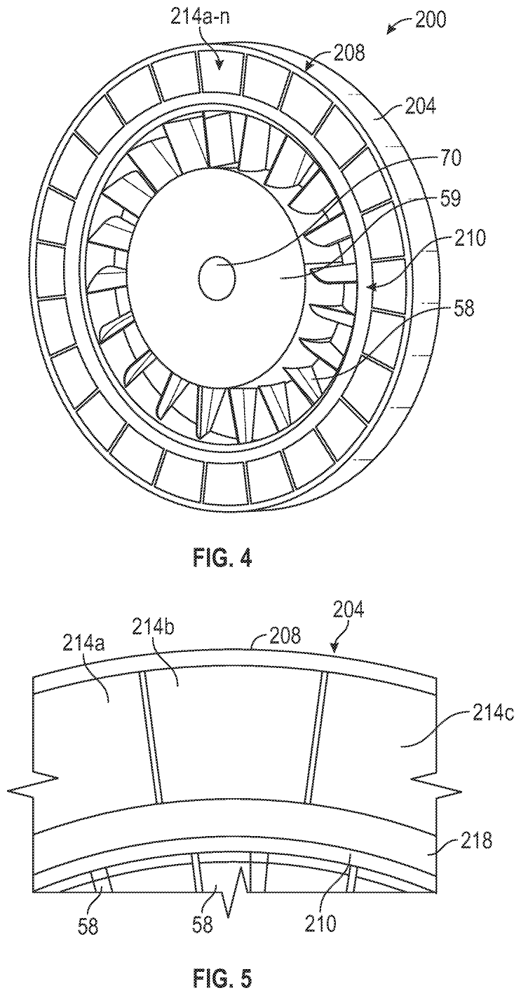

FIG. 4 is a perspective, partial view of a rotor assembly 200 of a surface mounted permanent magnet generator constructed in accordance with the present disclosure and designed for use as the rotor assembly 64. The rotor assembly 200 may comprise an annular generator rotor 204 surrounding and mechanically coupled to the plurality of turbine blades 58. The plurality of turbine blades 58 are mechanically coupled to the blade root 59 and, thus, to the second shaft 70.

As shown in FIG. 5, the generator rotor 204 is provided with a first annular retainer 208, a second annular retainer 210 in a coaxial relationship with the first annular retainer 208, a plurality of permanent magnets 214 positioned between the first annual retainer 208 and the second annular retainer 210. Three of the permanent magnets 214 are shown in FIG. 5 by way of example and labeled with the reference numerals 214a, 214b and 214c. The generator rotor 204 may also include a housing extending from the first annular retainer 208 to the second annular retainer 210. The housing can be connected to the first annular retainer 208 and to the second annular retainer 210 and serves to maintain the plurality of permanent magnets between the first annular retainer 208 and the second annular retainer 210. The second annular retainer 210 is positioned between the plurality of permanent magnets 214 and the plurality of turbine blades 58. The generator rotor 204 may also include an annular insulating ring 218 positioned between the plurality of permanent magnets 214 and the second annular retainer 210. The annular insulating ring 218 is constructed of a thermally insulating material so as to protect the plurality of permanent magnets 214 from the high heat of the combustion gasses being passed through the plurality of turbine blades 58. The first annular retainer 208 and the second annular retainer 210 can be constructed of a carbon fiber material, or a metal material, such as titanium or Inconel. In some embodiments, plurality of permanent magnets 214 are provided in a Halbach magnet configuration. The Halbach magnet configuration maximizes the magnetic flux on the outer surface of the plurality of permanent magnets 214 and reduces or eliminates the need for ferromagnetic steel between the plurality of permanent magnets 214 and the turbine blades 58. In some embodiments, the magnets are not glued to the first annular retainer 208 or the second annular retainer 210, but are instead kept in place by sizing the first annular retainer 208 and/or the second annular retainer 210 to hold the plurality of permanent magnets 214 in compression. In some embodiments, the plurality of permanent magnets 214 are samarium-cobalt magnets because the samarium-cobalt magnets can operate well at high temperatures. In some embodiments, the first annular retainer 208 and the second annular retainer 210 are made from a non-conductive material such as a carbon fiber composite.

### NON-LIMITING ILLUSTRATIVE EMBODIMENTS OF THE INVENTIVE CONCEPT(S)

The following is a numbered list of non-limiting illustrative embodiments of the inventive concept(s) disclosed herein:

Illustrative Embodiment 1. An electrical turbine generator comprising:
a movable shaft;
a rotor assembly comprising a plurality of blades not configured to compress gas and a generator rotor, the plurality of blades coupled to the generator rotor, the rotor assembly being supported by the movable shaft;
a stator assembly including a plurality of stator windings electro-magnetically coupled to the rotor assembly;
a housing supporting the rotor assembly and the stator assembly, the housing having an exhaust inlet opening and exhaust outlet opening, the exhaust inlet opening and the exhaust outlet opening aligned with the blades of the rotor assembly; and
a power converter in communication with the stator windings to convert electrical energy induced in the stator windings into an output current having at least one of a steady frequency and a steady voltage.

Illustrative Embodiment 2. The electrical turbine generator of illustrative embodiment 1, further comprising at least one bearing disposed between the housing and the movable shaft, the at least one bearing supporting the movable shaft of the rotor assembly within the housing and isolating rotation of the movable shaft from the housing.

Illustrative Embodiment 3. The electrical turbine generator of illustrative embodiment 1, further comprising a mechanical interface extending from the movable shaft, the mechanical interface operable to support the rotor assembly.

Illustrative Embodiment 4. The electrical turbine generator of illustrative embodiment 1, wherein the rotor assembly and the stator assembly comprise one of a switch reluctance generator, an induction generator, and a permanent magnet generator.

Illustrative Embodiment 5. The electrical turbine generator of illustrative embodiment 1, wherein the rotor assembly further comprises a blade root mechanically coupling the plurality of turbine blades to the movable shaft, the blade root being constructed of a solid, continuous material impermeable to high-pressure and high-temperature gases.

Illustrative Embodiment 6. The electrical turbine generator of illustrative embodiment 1, wherein the plurality of blades is disposed longitudinally along the movable shaft.

Illustrative Embodiment 7. The electrical turbine generator of illustrative embodiment 1, wherein the generator rotor is provided with a first annular retainer, a second annular retainer and a plurality of permanent magnets positioned between the first annular retainer and the second annular retainer.

Illustrative Embodiment 8. The electrical turbine generator of illustrative embodiment 7, wherein the plurality of permanent magnets are in a Hallbach configuration.

Illustrative Embodiment 9. The electrical turbine generator of illustrative embodiment 7, wherein the plurality of permanent magnets are constructed of samarium-cobalt.

Illustrative Embodiment 10. An apparatus, comprising:
a gas turbine engine comprising:
   a compressor section for compressing incoming air, the compressor section comprising a turbine shaft;
   a combustion section for receiving the compressed incoming air and igniting fuel and producing high-pressure and high-temperature gases;
   a turbine section having turbine blades supported by the turbine shaft, the turbine blades receiving the high-pressure and high-temperature gases so as to induce rotation to the turbine blades and the turbine shaft thereby extracting energy from the high-pressure and high-temperature gases and converting at least a portion of the high-pressure and high-temperature gases into rotational mechanical energy; and
   an exhaust gas housing defining a turbine exhaust gas outlet downstream of the turbine section; and
an electrical turbine generator comprising:
   a movable shaft;
   a rotor assembly surrounding the movable shaft and comprising a plurality of blades coupled to a generator rotor, the rotor assembly being supported by the movable shaft;
   a stator assembly including a plurality of stator windings electro-magnetically coupled to the rotor assembly;
   a housing supporting the rotor assembly and the stator assembly, the housing having an exhaust inlet opening and exhaust outlet opening, the exhaust inlet opening and the exhaust outlet opening aligned with the blades of the rotor assembly, the housing fluidly connecting the exhaust gas housing of the gas turbine engine to the exhaust inlet opening of the electrical turbine generator; and
   a power converter in communication with the stator windings to convert electrical energy induced in the stator windings into an output current having at least one of a steady frequency and a steady voltage.

Illustrative Embodiment 11. The apparatus of illustrative embodiment 10, wherein the exhaust gas housing of the gas turbine engine is mechanically coupled to the housing of the electrical turbine generator by one or more bolt.

Illustrative Embodiment 12. The apparatus of illustrative embodiment 10, wherein the exhaust inlet is in fluid communication with the turbine exhaust gas outlet of the exhaust gas housing.

Illustrative Embodiment 13. The apparatus of illustrative embodiment 10, wherein the turbine shaft and the movable shaft are not mechanically linked.

Illustrative Embodiment 14. The apparatus of illustrative embodiment 10, wherein the plurality of blades of the rotor assembly are operable to receive the high-pressure and high-temperature gases generated by the gas turbine engine and induce rotation in the movable shaft.

Illustrative Embodiment 15. The apparatus of illustrative embodiment 10, wherein the electrical turbine generator further comprises at least one bearing disposed between the housing and the movable shaft, the at least one bearing supporting the movable shaft within the housing and isolating rotation of the movable shaft from the housing.

Illustrative Embodiment 16. The apparatus of illustrative embodiment 10, wherein the electrical turbine generator further comprises a mechanical interface extending from the movable shaft, the mechanical interface operable to support the rotor assembly.

Illustrative Embodiment 17. The apparatus of illustrative embodiment 10, wherein the rotor assembly and the stator assembly comprise one of a switch reluctance generator, an induction generator, and a permanent magnet generator.

Illustrative Embodiment 18. The apparatus of illustrative embodiment 10, wherein the rotor assembly further comprises a blade root mechanically coupling the plurality of turbine blades to the movable shaft, the blade root constructed of a solid, continuous material impermeable to the high-pressure and high-temperature gases.

Illustrative Embodiment 19. The apparatus of illustrative embodiment 10, wherein the plurality of blades of the rotor assembly are disposed longitudinally along the movable shaft.

Illustrative Embodiment 20. The apparatus of illustrative embodiment 10, wherein the turbine shaft and the movable shaft are axially aligned.

Illustrative Embodiment 21. The apparatus of illustrative embodiment 10, wherein the turbine shaft and the movable shaft rotate independently of each other.

Illustrative Embodiment 22. A method, comprising:
positioning a gas inlet of a rotor assembly of an electrical turbine generator to receive an exhaust gas stream from a gas turbine engine, the electrical turbine generator having an electrical rotor assembly coupled to the rotor assembly, and a stator assembly electro-magnetically coupled with the electrical rotor assembly.

Illustrative Embodiment 23. The method of illustrative embodiment 22, further comprising:
mechanically coupling a housing of the electrical turbine generator to an exhaust gas housing of the gas turbine engine.

Illustrative Embodiment 24. The method of illustrative embodiment 22, further comprising:
connecting a power converter to one or more winding of the stator assembly, the power converter operable to convert an induced current received by the stator assembly into an output current having a predetermined format.

From the above description and examples, it is clear that the inventive concepts disclosed and claimed herein are well adapted to attain the advantages mentioned herein. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. An electrical turbine generator comprising:
a movable shaft;
a rotor assembly comprising a plurality of blades not configured to compress gas and a generator rotor, the plurality of blades coupled to the generator rotor, the rotor assembly being supported by the movable shaft;
a stator assembly including a plurality of stator windings electro-magnetically coupled to the rotor assembly;
a housing supporting the rotor assembly and the stator assembly, the housing having an exhaust inlet opening and exhaust outlet opening, the exhaust inlet opening and the exhaust outlet opening aligned with the blades of the rotor assembly; and
a power converter in communication with the stator windings to convert electrical energy induced in the stator windings into an output current having at least one of a steady frequency and a steady voltage.

2. The electrical turbine generator of claim 1, further comprising at least one bearing disposed between the housing and the movable shaft, the at least one bearing supporting the movable shaft of the rotor assembly within the housing and isolating rotation of the movable shaft from the housing.

3. The electrical turbine generator of claim 1, further comprising a mechanical interface extending from the movable shaft, the mechanical interface operable to support the rotor assembly.

4. The electrical turbine generator of claim 1, wherein the rotor assembly and the stator assembly comprise one of a switch reluctance generator, an induction generator, and a permanent magnet generator.

5. The electrical turbine generator of claim 1, wherein the rotor assembly further comprises a blade root mechanically coupling the plurality of turbine blades to the movable shaft, the blade root being constructed of a solid, continuous material impermeable to high-pressure and high-temperature gases.

6. The electrical turbine generator of claim 1, wherein the plurality of blades is disposed longitudinally along the movable shaft.

7. The electrical turbine generator of claim 1, wherein the generator rotor is provided with a first annular retainer, a second annular retainer and a plurality of permanent magnets positioned between the first annular retainer and the second annular retainer.

8. The electrical turbine generator of claim 7, wherein the plurality of permanent magnets are in a Hallbach configuration.

9. The electrical turbine generator of claim 7, wherein the plurality of permanent magnets are constructed of samarium-cobalt.

10. An apparatus, comprising:
a gas turbine engine comprising:
a compressor section for compressing incoming air, the compressor section comprising a turbine shaft;
a combustion section for receiving the compressed incoming air and igniting fuel and producing high-pressure and high-temperature gases;
a turbine section having turbine blades supported by the turbine shaft, the turbine blades receiving the high-pressure and high-temperature gases so as to induce rotation to the turbine blades and the turbine shaft thereby extracting energy from the high-pressure and high-temperature gases and converting at least a portion of the high-pressure and high-temperature gases into rotational mechanical energy; and
an exhaust gas housing defining a turbine exhaust gas outlet downstream of the turbine section; and
an electrical turbine generator comprising:
a movable shaft;
a rotor assembly surrounding the movable shaft and comprising a plurality of blades coupled to a generator rotor, the rotor assembly being supported by the movable shaft;
a stator assembly including a plurality of stator windings electro-magnetically coupled to the rotor assembly;
a housing supporting the rotor assembly and the stator assembly, the housing having an exhaust inlet opening and exhaust outlet opening, the exhaust inlet opening and the exhaust outlet opening aligned with the blades of the rotor assembly, the housing fluidly connecting the exhaust gas housing of the gas turbine engine to the exhaust inlet opening of the electrical turbine generator; and
a power converter in communication with the stator windings to convert electrical energy induced in the stator windings into an output current having at least one of a steady frequency and a steady voltage.

11. The apparatus of claim 10, wherein the exhaust gas housing of the gas turbine engine is mechanically coupled to the housing of the electrical turbine generator by one or more bolt.

12. The apparatus of claim 10, wherein the exhaust inlet is in fluid communication with the turbine exhaust gas outlet of the exhaust gas housing.

13. The apparatus of claim 10, wherein the turbine shaft and the movable shaft are not mechanically linked.

14. The apparatus of claim 10, wherein the plurality of blades of the rotor assembly are operable to receive the high-pressure and high-temperature gases generated by the gas turbine engine and induce rotation in the movable shaft.

15. The apparatus of claim 10, wherein the electrical turbine generator further comprises at least one bearing disposed between the housing and the movable shaft, the at least one bearing supporting the movable shaft within the housing and isolating rotation of the movable shaft from the housing.

16. The apparatus of claim 10, wherein the electrical turbine generator further comprises a mechanical interface extending from the movable shaft, the mechanical interface operable to support the rotor assembly.

17. The apparatus of claim 10, wherein the rotor assembly and the stator assembly comprise one of a switch reluctance generator, an induction generator, and a permanent magnet generator.

18. The apparatus of claim 10, wherein the rotor assembly further comprises a blade root mechanically coupling the plurality of turbine blades to the movable shaft, the blade root constructed of a solid, continuous material impermeable to the high-pressure and high-temperature gases.

19. The apparatus of claim 10, wherein the plurality of blades of the rotor assembly are disposed longitudinally along the movable shaft.

20. The apparatus of claim 10, wherein the turbine shaft and the movable shaft are axially aligned.

21. The apparatus of claim 10, wherein the turbine shaft and the movable shaft rotate independently of each other.

22. A method, comprising:
positioning a gas inlet of a rotor assembly of an electrical turbine generator to receive an exhaust gas stream from a gas turbine engine, the electrical turbine generator having an electrical rotor assembly coupled to the rotor assembly, and a stator assembly electro-magnetically coupled with the electrical rotor assembly.

23. The method of claim 22, further comprising:
mechanically coupling a housing of the electrical turbine generator to an exhaust gas housing of the gas turbine engine.

24. The method of claim 22, further comprising:
connecting a power converter to one or more winding of the stator assembly, the power converter operable to convert an induced current received by the stator assembly into an output current having a predetermined format.
